(19) United States
(12) Patent Application Publication
(10) Pub. No.: US 2025/0125485 A1
(43) Pub. Date: Apr. 17, 2025

(54) SEPARATOR AND BATTERY

(71) Applicant: ZHUHAI COSMX BATTERY CO., LTD., Zhuhai (CN)

(72) Inventors: Zulai ZHANG, Zhuhai (CN); Jianming LIU, Zhuhai (CN)

(73) Assignee: ZHUHAI COSMX BATTERY CO., LTD., Zhuhai (CN)

(21) Appl. No.: 19/000,596

(22) Filed: Dec. 23, 2024

Related U.S. Application Data
(63) Continuation-in-part of application No. PCT/CN2023/101847, filed on Jun. 21, 2023.

(30) Foreign Application Priority Data
Jul. 8, 2022 (CN) 202210801534.9

(51) Int. Cl. H01M 50/414; C08G 65/44; H01M 10/0525; H01M 50/434; H01M 50/443; H01M 50/446; H01M 50/449; H01M 50/489; H01M 50/497

(52) U.S. Cl. CPC H01M 50/414; C08G 65/44; H01M 10/0525; H01M 50/434; H01M 50/443; H01M 50/446; H01M 50/449; H01M 50/489; H01M 50/497

(57) ABSTRACT

A separator contains a first monomer and/or a first polymer. The first monomer has a structure shown in Formula (I) or Formula (II), R₁ and R₂ are each independently selected from H, —CₙNR₃, or —CₙNR₄R₅, and n is an integer from 0 to 4; NR₃ is a 4-7 membered heterocyclic ring, R₃ contains 0 to 2 oxygen atoms and/or 0 to 2 nitrogen atoms, and the balance are carbon atoms. There is or there is no grafting group R₆ on R₃, R₆ is —CₘOH, and m is an integer from 0 to 2; and R₄ and R₅ are each independently a C1-C4 aliphatic chain.

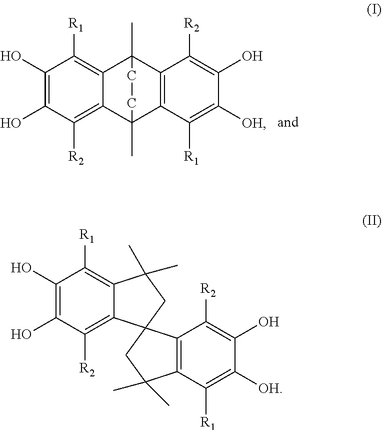

### CROSS-REFERENCE TO RELATED APPLICATIONS

The present disclosure is a continuation-in-part application of International Application No. PCT/CN2023/101847, filed on Jun. 21, 2023, and which claims priority to Chinese Patent Application No. CN202210801534.9, filed on Jul. 8, 2022. The disclosures of the aforementioned applications are hereby incorporated by reference in their entireties.

### TECHNICAL FIELD

The present disclosure relates to the field of battery technologies, and specifically relates to a separator and a battery including the separator.

### BACKGROUND

In recent years, batteries have been widely used in a smartphone, a tablet computer, intelligent wearing, an electric tool, an electric vehicle, and other fields. With increasing application of batteries, the demands of consumers on the service life and the application safety of the batteries are continuously increased. This requires that the batteries have long cycle life while taking high safety performance into account.

Currently, there are a lot of potential safety hazards during use of batteries. For example, after the battery is used for a period of time, during cycling, especially during high-rate cycling, internal temperature rise of the battery is too high due to too high internal resistance of the battery, which is easy to cause a serious safety accident such as a fire or even an explosion.

Therefore, it is very important to develop a battery having lower internal resistance, thereby having better cycling performance and higher safety performance.

### SUMMARY

The objective of the present disclosure is to overcome the problems in a conventional technology by providing a separator and a battery including the separator. The separator of the present disclosure has high wettability, and can achieve a lower ionic conductivity deviation ratio; the battery prepared from the separator of the present disclosure has a lower internal resistance, thereby having better cycling performance and higher safety.

It has been found through study that the internal resistance of the battery can be reduced by increasing the wettability of the separator.

Through further in-depth study, it has been further found that, in order to increase the wettability of the separator, more “ion channels” may be formed on the separator by modifying the separator with specific compounds, instead of relying on an inherent pore structure in the separator to conduct ions. These “ion channels” have a guiding effect on ions, so that on one hand, a speed of ions passing through the separator is improved; on the other hand, the consistency of conducting ions of the separator is improved, and the conductivity of ions on the separator is more uniform. After a lot of in-depth study, the specific compounds with good modification effect on the separator are screened out.

In order to achieve the above objective, a first aspect of the present disclosure provides a separator, where the separator contains a first monomer and/or a first polymer, and the first polymer is obtained by polymerizing the first monomer;
the first monomer has a structure shown in Formula (I) or Formula (II),

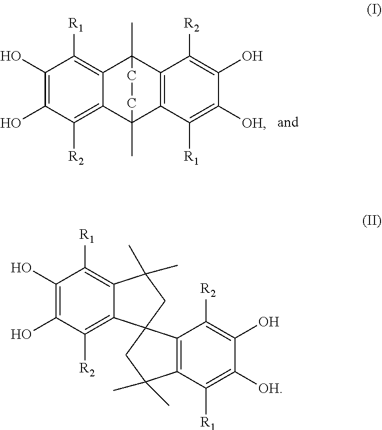

where R₁ and R₂ are each independently selected from H, —CₙNR₃, or —CₙNR₄R₅, and n is an integer from 0 to 4; NR₃ is a 4-7 membered heterocyclic ring, R₃ contains 0 to 2 oxygen atoms and/or 0 to 2 nitrogen atoms, and the balance are carbon atoms; there is or there is no grafting group R₆ on R₃, R₆ is —CₘOH, and m is an integer from 0 to 2; and R₄ and R₅ are each independently a C1-C4 aliphatic chain.

According to a second aspect of the present disclosure, a battery is provided, and a separator of the battery is the separator according to the first aspect of the present disclosure.

Based on the foregoing technical solutions, the present disclosure has at least the following advantages over the conventional technology.

Firstly, the separator of the present disclosure has good wettability and fast ion conducting speed.

Secondly, the separator of the present disclosure has good consistency of conducting ions, and low ionic conductivity deviation ratio.

Thirdly, the battery of the present disclosure has good internal current density consistency.

Fourthly, the battery of the present disclosure has low internal resistance.

Fifth, the battery of the present disclosure has high capacity retention rate and long cycle life;

Sixth, the battery of the present disclosure has good safety performance.

Lastly, due to the improvement of the wettability of the separator, an aging time is also shortened, so that the battery of the present disclosure has high production efficiency and low production cost.

Other features and advantages of the present disclosure will be described in detail in the following detailed description.

### DETAILED DESCRIPTION OF THE EMBODIMENTS

Specific implementations of the present disclosure are described below in detail. It should be understood that the specific implementations described herein are merely used for the purposes of illustrating and explaining the present disclosure, rather than limiting the present disclosure.

A first aspect of the present disclosure provides a separator, where the separator contains a first monomer and/or a first polymer, and the first polymer is obtained by polymerizing the first monomer;
the first monomer has a structure shown in Formula (I) or Formula (II),

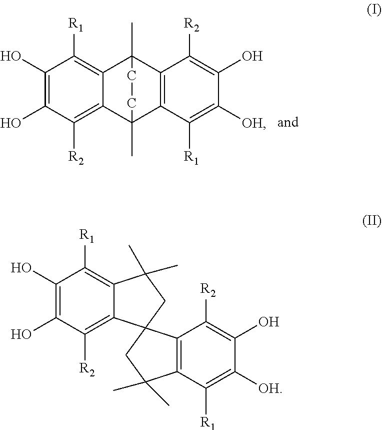

where R₁ and R₂ are each independently selected from H, —CₙNR₃, or —CₙNR₄R₅, and n is an integer from 0 to 4; NR₃ is a 4-7 membered heterocyclic ring, R₃ contains 0 to 2 oxygen atoms and/or 0 to 2 nitrogen atoms, and the balance are carbon atoms; there is or there is no grafting group R₆ on R₃, R₆ is —CₘOH, and m is an integer from 0 to 2; and R₄ and R₅ are each independently a C1-C4 aliphatic chain.

In the present disclosure, by adding the first monomer with the above-mentioned specific structure and/or the first polymer obtained by polymerization of the first monomer into the separator, the separator has been able to achieve lower ionic conductivity deviation ratio, better wettability and lower battery internal resistance than the conventional technology. In order to further improve the effect, one or more technical features may be further optimized.

The first polymer is obtained by polymerizing the first monomer, and the polymerizing may be homopolymerization of the first monomer or copolymerization of the first monomer with other monomers. In a specific mode of the present disclosure, when other monomers are not mentioned, the first polymer refers to a polymer obtained by homopolymerization of the first monomer. However, it may be understood that the polymer obtained by copolymerization of monomers of conventional materials used in the battery separator with the first monomer is also within the protection scope of the first polymer disclosed in the present disclosure. The separator may contain only the first monomer, or may contain only the first polymer, and may also contain the first monomer and the first polymer at the same time.

The first monomer has the structure shown in Formula (I) or Formula (II). It can be seen from the structural formulas that the first monomer has two benzene rings and at least four hydroxyl groups which are centrosymmetric.

R₁ and R₂ are the same or different and are each independently selected from H, —CₙNR₃, or —CₙNR₄R₅.

n represents the number of carbon atoms connecting the benzene ring to the nitrogen atom, and n may be an integer from 0 to 4 (for example, 0, 1, 2, or 3).

In an example, n is 1 or 2.

The N atom and the R₃ group in —CₙNR₃ together form a ring structure, which may be a 4-7 membered heterocyclic ring (such as four-membered heterocyclic ring, five-membered heterocyclic ring, six-membered heterocyclic ring, or seven-membered heterocyclic ring).

In an example, the N atom and the R₃ group in —CₙNR₃ together form a ring structure, which is a five-membered heterocyclic ring, or a six-membered heterocyclic ring.

The R₃ group may be entirely composed of carbon atoms (excluding hydrogen atoms), and may also contain 0-2 (such as 0, 1, or 2) oxygen atoms and/or 0-2 (such as 0, 1, or 2) nitrogen atoms.

In a specific implementation, the R₃ group is composed of a plurality of carbon atoms and one oxygen atom.

In another specific implementation, the R₃ group is entirely composed of carbon atoms.

There may be no grafting group on R₃.

According to a specific implementation, there may also be a grafting group R₆ on R₃, where R₆ is —CₘOH and m is an integer from 0 to 2 (such as 0, 1, or 2).

In an example, a grafting site of the grafting group R₆ is aligned with the N atoms in the NR₃ heterocyclic ring

For example, —CₙNR₃ includes, but is not limited to, the following structures:

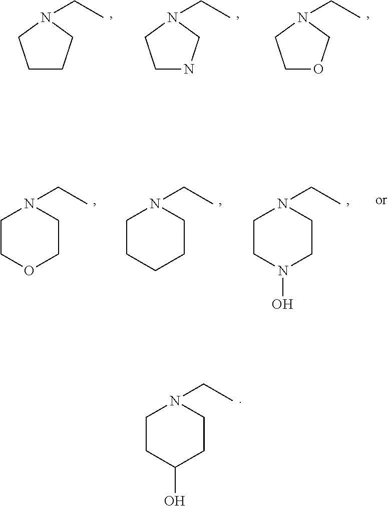

There is no ring structure in —CₙNR₄R₅, R₄ and R₅ are the same or different and are each independently a C1-C4 aliphatic chain.

According to a specific implementation, R₄ and R₅ are selected from methyl and ethyl.

For example, the first monomer includes, but is not limited to, the following structures:

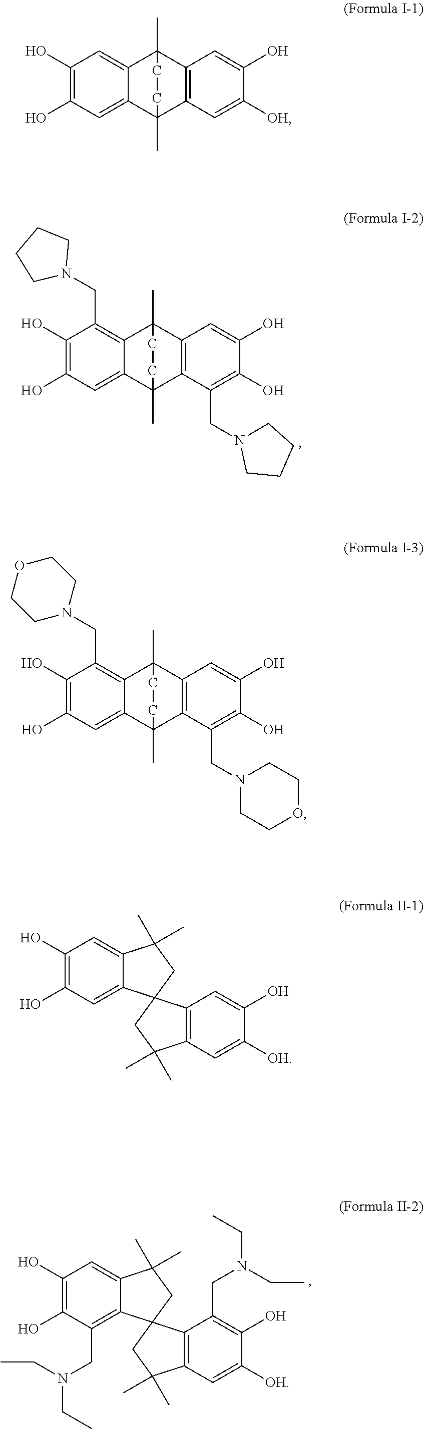 [SMILES: CC12CCC(C)(c3cc(O)c(O)cc31)c1cc(O)c(O)cc12 ; CC12CCC(C)(c3cc(O)c(O)c(CN4CCCC4)c31)c1c2cc(O)c(O)c1CN1CCCC1 ; CC12CCC(C)(c3cc(O)c(O)c(CN4CCOCC4)c31)c1c2cc(O)c(O)c1CN1CCOCC1 ; CC1(C)CC2(CC(C)(C)c3cc(O)c(O)cc32)c2cc(O)c(O)cc21 ; CCN(CC)Cc1c(O)c(O)cc2c1C1(CC2(C)C)CC(C)(C)c2cc(O)c(O)c(CN(CC)CC)c21]

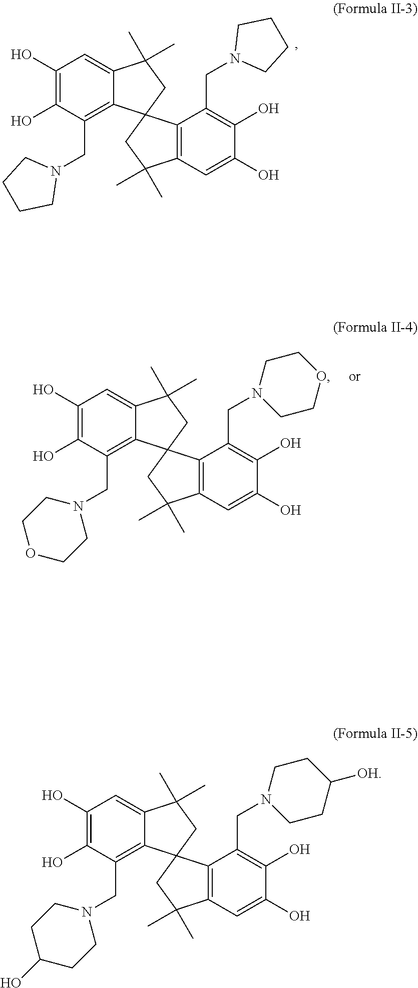 [SMILES: CC1(C)CC2(CC(C)(C)c3cc(O)c(O)c(CN4CCCC4)c32)c2c1cc(O)c(O)c2CN1CCCC1 ; CC1(C)CC2(CC(C)(C)c3cc(O)c(O)c(CN4CCOCC4)c32)c2c1cc(O)c(O)c2CN1CCOCC1 ; CC1(C)CC2(CC(C)(C)c3cc(O)c(O)c(CN4CCC(O)CC4)c32)c2c1cc(O)c(O)c2CN1CCC(O)CC1]

Any position of at least one of the first monomer and the first polymer in the separator is within the protection scope of the present disclosure.

According to a specific implementation, the separator includes a substrate layer and an optional heat-resistant layer and/or an optional adhesive layer (the term “optionally” means that there may or may not be); the heat-resistant layer covers one side or two side surfaces of the substrate layer; the adhesive layer covers a surface of the heat-resistant layer, and/or the adhesive layer covers a surface of the substrate layer. In an example, the separator includes an adhesive layer, a heat-resistant layer, a substrate layer, a heat-resistant layer, and an adhesive layer that are sequentially disposed. In another example, the separator includes an adhesive layer, a substrate layer, a heat-resistant layer, and an adhesive layer that are sequentially disposed.

At least one of the substrate layer, the heat-resistant layer, or the adhesive layer contains the first monomer and/or the first polymer. The substrate layer, the heat-resistant layer, and the adhesive layer may all contain the first monomer and/or the first polymer, or may include only one or more of the first monomer and/or the first polymer. Therefore, at least one layer of the substrate layer, the heat-resistant layer, or the adhesive layer containing the first monomer and/or the first polymer, pertains to the protection scope of the present disclosure, and can achieve the objective of the present disclosure, and has a better technical effect. As used herein, the term “one layer” refers to one layer rather than one type of layer, for example, when the adhesive layer contains the first monomer and/or the first polymer, it is not required that both upper and lower adhesive layers both contain the first monomer and/or the first polymer.

In an example, at least the substrate layer contains the first monomer and/or the first polymer.

In an example, the substrate layer, and at least one of the heat-resistant layer and the adhesive layer contain the first monomer and/or the first polymer.

In an example, the substrate layer contains the first monomer and/or the first polymer.

In an example, the heat-resistant layer contains the first monomer and/or the first polymer.

In an example, the adhesive layer contains the first monomer and/or the first polymer.

In an example, the substrate layer and the adhesive layer contain the first monomer and/or the first polymer.

In an example, the substrate layer and the heat-resistant layer contain the first monomer and/or the first polymer.

In an example, the heat-resistant layer and the adhesive layer contain the first monomer and/or the first polymer.

In an example, the substrate layer, the heat-resistant layer and the adhesive layer all contain the first monomer and/or the first polymer.

In the same layer, at least one of the first monomer and the first polymer with only one structure may be contained, and at least one of the first monomer and the first polymer with multiple structures may also be contained.

The form in which at least one of the first monomer and the first polymer exist in the separator may not be particularly limited, for example, at least one of the first monomer and the first polymer may exist in the separator in the form of doping (blending), grafting, partial coating, and the like.

In an example, a material of the substrate layer includes a material obtained by grafting and modifying a matrix material with the first monomer.

In a specific implementation, the material of the substrate layer is the material obtained by grafting and modifying the matrix material with the first monomer.

In an example, relative to 100 parts by weight of the matrix material, a content of the first monomer may range from 0.1 part by weight to 10 parts by weight (for example, 1 part by weight, 2 parts by weight, 3 parts by weight, 4 parts by weight, 5 parts by weight, 6 parts by weight, 7 parts by weight, 8 parts by weight, 9 parts by weight, or 10 parts by weight).

In an example, relative to 100 parts by weight of the matrix material, the content of the first monomer may range from 0.5 part by weight to 5 parts by weight.

The matrix material may be a conventional material used as a separator substrate in the field, such as one or more selected from polyethylene, polypropylene, polyvinylidene fluoride, polyimide, polyethylene terephthalate, polybutylene terephthalate, polystyrene, polynaphthalene system polymer, polyamide, poly(p-phenylene-2,6-benzoxadiazole), or aramid.

In an example, the material of the substrate layer is obtained by the following grafting and modifying method:
(a1) performing a first plasma activation treatment on a matrix material;
(a2) performing a first oxidation treatment on the material obtained in the step (a1); and
(a3) performing a first contact reaction on the material obtained in the step (a2) and the first monomer in a first solvent under a protective atmosphere.

In the step (a1), a condition of the first plasma activation treatment includes: a time of 3 minutes to 10 minutes (for example, 3 minutes, 4 minutes, 5 minutes, 6 minutes, 7 minutes, 8 minutes, 9 minutes, or 10 minutes).

In an example, the condition of the first plasma activation treatment includes: the time of 5 minutes to 8 minutes.

In the step (a2), the first oxidation treatment includes the steps of placing the material obtained in the step (a1) in oxygen, and controlling a condition to include: a temperature of 30° C. to 60° C. (for example, 30° C., 35° C., 40° C., 45° C., 50° C., 55° C., or 60° C.), and a time of 100 minutes to 250 minutes (for example, 100 minutes, 120 minutes, 150 minutes, 180 minutes, 200 minutes, 220 minutes, or 250 minutes). After the step (a2), the matrix material rich in peroxide is obtained.

In an example, the first oxidation treatment includes the steps of placing the material obtained in the step (a1) in oxygen, and controlling a condition to include: a temperature of 40° C. to 50° C. and a time of 120 minutes to 200 minutes.

In the step (a3), a manner of the first contact reaction may include: soaking the material obtained in the step (a2) into a solution containing a first monomer and a first solvent.

In the step (a3), a condition of the first oxidation treatment includes: a temperature of 50° C. to 80° C. (for example, 50° C., 55° C., 60° C., 65° C., 70° C., 75° C., or 80° C.), and a time of 6 hours to 10 hours (for example, 6 hours, 7 hours, 8 hours, 9 hours, or 10 hours).

In the step (a3), a condition of the first contact reaction includes: a temperature of 55° C. to 65° C., and a time of 7 hours to 9 hours.

In the step (a3), the first solvent is selected from one or more of acetone, tetrahydrofuran, dichloromethane, chloroform, dimethylformamide, N-methyl-2-pyrrolidone, cyclohexane, methanol, ethanol, isopropanol, or water.

Thus, the substrate layer graft and modified by the first monomer in an implementation can be obtained.

Those skilled in the art can use other methods to make the implementation of the first monomer into the substrate layer all fall within the protection scope of the present disclosure.

A thickness of the substrate layer may range from 2 μm to 20 μm, for example, 2 μm, 3 m, 4 μm, 5 μm, 6 μm, 7 μm, 8 μm, 9 μm, 10 μm, 12 μm, 16 μm, 18 μm, or 20 μm.

The heat-resistant layer may also contain the first monomer and/or the first polymer, and at least one of the first monomer and the first polymer may be present in the heat-resistant layer in various forms.

In an example, the heat-resistant layer includes ceramic particles, and the ceramic particles have a core-shell structure, where a shell material of the ceramic particles includes the first polymer.

In a specific implementation, the heat-resistant layer includes ceramic particles, and the ceramic particles have a core-shell structure, where shell materials of the ceramic particles are the first polymer and a second polymer, and the second polymer includes at least one of styrene, vinyl chloride, perfluoropropylene, chlorotrifluoroethylene, tetrafluoroethylene, vinylidene chloride, tetrachloroethylene, acrylate or acrylonitrile. The acrylate is selected from one or more of methyl acrylate, ethyl acrylate, n-propyl acrylate, isopropyl acrylate, n-butyl acrylate, isobutyl acrylate, or methacrylate.

In a specific implementation, the heat-resistant layer includes ceramic particles, and the ceramic particles have a core-shell structure, where a shell material of the ceramic particles is the first polymer, and the shell material of the ceramic particles is selected from one or more of aluminum oxide, boehmite, magnesium oxide, boron nitride, or magnesium hydroxide.

Other conventional components may also be included in the heat-resistant layer, for example, the heat-resistant layer further contains a first binder. The heat-resistant layer may be obtained by mixing the modified ceramic particles with the first binder, and then coating and curing.

In an example, the shell material of the ceramic particles includes a homopolymer of the first monomer.

In an example, the shell material of the ceramic particles is the homopolymer of the first monomer.

Based on a total weight of the ceramic particles, a content of the shell material of the ceramic particles may range from 5 wt % to 50 wt % (for example, 5 wt %, 10 wt %, 15 wt %, 20 wt %, 25 wt %, 30 wt %, 35 wt %, 40 wt %, 45 wt %, or 50 wt %), and a content of a core material of the ceramic particles ranges from 50 wt % to 95 wt % (for example, 95 wt %, 90 wt %, 85 wt %, 80 wt %, 75 wt %, 70 wt %, 65 wt %, 60 wt %, 55 wt %, or 50 wt %). It may be understood that the content of the shell material of the ceramic particles may range from 5 wt % to 50 wt %, and the content of the core material of the ceramic particles may range from range from 50 wt % to 95 wt %, but it needs to satisfy that: a sum of the content of the shell material of the ceramic particles and the content of the core material of the ceramic particles is 100 wt %.

According to a specific implementation, based on the total weight of the ceramic particles, the content of the shell material of the ceramic particles ranges from 15 wt % to 25 wt %, and the content of the core material of the ceramic particles ranges from 75 wt % to 85 wt %.

According to a specific implementation, the shell of the ceramic particle is prepared by using the following method:
(b1) performing a second contact on the core material and the first monomer in a second solvent to obtain a solid-liquid mixture; and
(b2) drying the solid-liquid mixture.

In the step (b1), the second solvent is selected from one or more of acetone, tetrahydrofuran, dichloromethane, chloroform, dimethylformamide, N-methyl-2-pyrrolidone, cyclohexane, methanol, ethanol, isopropanol, or water.

In the step (b1), in order to avoid loss in the process, an amount of the first monomer may be excessive, and the amount of the first monomer is more than an actual shell-forming amount, and the amount needs to meet the requirements of the above-mentioned core-shell ratio.

In the step (b1), the second contact is, for example, stirring and mixing.

In the step (b1), the first monomer in the solid-liquid mixture has been partially and/or completely polymerized. The solid-liquid mixture contains the first monomer and/or the first polymer.

In the step (b2), the drying is, for example, drying by vacuum heating or drying by spraying.

Thus, the modified ceramic particles having the shell (the first monomer homopolymerized shell)-core structure are obtained.

The heat-resistant layer may further include a first binder.

In an example, the first binder in the heat-resistant layer is selected from one or more of polytetrafluoroethylene, polyvinylidene fluoride, hexafluoropropylene-vinylidene fluoride copolymer, polyimide, polyacrylonitrile, polymethyl methacrylate, polyacrylic acid, or polyacrylate.

According to a specific implementation, the heat-resistant layer is obtained by mixing the modified ceramic particles with the first binder, and then coating and curing. Depending on the demand for heat resistance, the content of the ceramic particles may be selected in a larger range. Based on a total weight of the heat-resistant layer, a content of the ceramic particles may range from 20 wt % to 99 wt % (for example, 20 wt %, 30 wt %, 40 wt %, 50 wt %, 60 wt %, 70 wt %, 80 wt %, 90 wt %, or 99 wt %), and a content of the first binder may range from 1 wt % to 80 wt % (for example, 1 wt %, 10 wt %, 20 wt %, 30 wt %, 40 wt %, 50 wt %, 60 wt %, 70 wt %, or 80 wt %).

In an example, based on the total weight of the heat-resistant layer, the content of the ceramic particles may range from 50 wt % to 95 wt %, and the content of the first binder may range from 5 wt % to 50 wt %.

The first binder may not contain the first monomer and/or the first polymer.

The first binder may also contain the first monomer and/or the first polymer, and may be obtained by referring to a modification method of the second binder below.

A thickness of the heat-resistant layer may range from 0.5 μm to 4 μm, for example, 0.5 m, 1 μm, 1.5 μm, 2 μm, 2.5 μm, 3 μm, or 4 m.

The adhesive layer may also contain the first monomer and/or the first polymer, and at least one of the first monomer and the first polymer may be present in the adhesive layer in various forms.

In an example, the adhesive layer contains a modified second binder, and the modified second binder is obtained by grafting the first monomer and/or the first polymer on a base binder.

In an example, the adhesive layer is obtained by coating and curing a mixed slurry of the modified second binder and a third solvent (i.e., the adhesive layer includes the modified second binder and the third solvent that may remain), and the modified second binder is obtained by grafting the first monomer and/or the first polymer onto a base binder.

In an example, the third solvent is selected from one or more of N-methylpyrrolidone, N,N-dimethylacetamide, N,N-dimethylformamide, acetone, or water.

In an example, an amount ratio of the modified second binder to the third solvent ranges from 1:5 to 1:50 (for example, 1:5, 1:10, 1:15, 1:20, 1:25, 1:30, 1:35, 1:40, 1:45, or 1:50).

In an example, the amount ratio of the modified second binder to the third solvent ranges from 1:6 to 1:20.

In an example, the modified second binder is obtained by the following grafting and modifying method:
(c1) performing a second plasma activation treatment on a base binder;
(c2) performing a second oxidation treatment on the material obtained in the step (c1); and
(c3) performing a third contact reaction on the material obtained in the step (c2) and the first monomer in a fourth solvent under a protective atmosphere.

In the step (c1), a condition of the plasma activation treatment includes: a time of 3 minutes to 10 minutes (for example, 3 minutes, 4 minutes, 5 minutes, 6 minutes, 7 minutes, 8 minutes, 9 minutes, or 10 minutes).

In the step (c1), a condition of the plasma activation treatment includes: a time of 5 minutes to 8 minutes.

In the step (c2), the second oxidation treatment includes the steps of placing the material obtained in the step (c1) in oxygen, and controlling a condition to include: a temperature of 30° C. to 60° C. (for example, 30° C., 35° C., 40° C., 45° C., 50° C., 55° C., or 60° C.), and a time of 100 minutes to 250 minutes (for example, 100 minutes, 120 minutes, 150 minutes, 180 minutes, 200 minutes, 220 minutes, or 250 minutes). After the step (c2), the base binder rich in peroxide is obtained.

In an example, in the step (c2), the second oxidation treatment includes the steps of placing the material obtained in the step (c1) in oxygen, and controlling a condition to include: a temperature of 40° C. to 50° C., and a time of 120 minutes to 200 minutes.

In the step (c3), a manner of the third contact reaction may include: soaking the material obtained in the step (c2) in a solution containing a first monomer and a fourth solvent.

In the step (c3), a condition of the third contact reaction includes: a temperature of 50° C. to 80° C. (for example, 50° C., 55° C., 60° C., 65° C., 70° C., 75° C., or 80° C.), and a time of 6 hours to 10 hours (for example, 6 hours, 7 hours, 8 hours, 9 hours, or 10 hours).

In an example, in the step (c3), the condition of the third contact reaction includes: a temperature of 55° C. to 65° C., and a time of 7 hours to 9 hours.

In the step (c3), the fourth solvent is selected from one or more of acetone, tetrahydrofuran, dichloromethane, chloroform, dimethylformamide, N-methyl-2-pyrrolidone, cyclohexane, methanol, ethanol, isopropanol, or water.

The base binder, for example, is selected from one or more of polytetrafluoroethylene, polyvinylidene fluoride, hexafluoropropylene-vinylidene fluoride copolymer, polyimide, polyacrylonitrile, polymethyl methacrylate, polyacrylic acid, or polyacrylate.

In an example, relative to 100 parts by weight of the base binder, an amount of the first monomer may range from 0.1 part by weight to 20 parts by weight (for example, 0.1 part by weight, 0.5 part by weight, 1 part by weight, 5 parts by weight, 10 parts by weight, 15 parts by weight, or 20 parts by weight).

In an example, relative to 100 parts by weight of the base binder, the amount of the first monomer may range from 1 part by weight to 15 parts by weight.

In an example, relative to 100 parts by weight of the base binder, the amount of the first monomer may range from 8 parts by weight to 12 parts by weight.

A thickness of the adhesive layer may range from 0.5 μm to 2 μm. For example, the thickness is 0.5 μm, 1 μm, or 2 m.

The modification manners of the substrate layer, the heat-resistant layer, and the adhesive layer have been illustratively described respectively.

The content of at least one of the first monomer and the first polymer in the separator may be selected within a larger range depending on a number of layers and a desired target of distribution, for example, relative to a total weight of the separator, the content of at least one of the first monomer and the first polymer may range from 0.1 wt % to 20 wt % (for example, 0.1 wt %, 0.5 wt %, 1 wt %, 5 wt %, 10 wt %, 15 wt %, or 20 wt %).

In an example, relative to the total weight of the separator, the content of at least one of the first monomer and the first polymer may range from 0.5 wt % to 10 wt %.

By introducing the first monomer/the first polymer into the separator, the ion channel of the separator is increased, the consistency of conducting ions of the separator is improved, the wettability of the separator and the electrolyte solution is improved, and the speed and uniformity of the ions passing through the separator are accelerated.

According to a second aspect of the present disclosure, a battery is provided, and a separator of the battery is the separator according to the first aspect of the present disclosure.

Materials and preparation methods other than the battery separator of the battery can be performed in a manner in the art, and the effects of reducing the internal resistance, improving the cycling performance, and improving the safety performance can all be achieved.

The battery is a lithium-ion battery.

The battery further includes a positive electrode plate, a negative electrode plate, a non-aqueous electrolyte solution.

The positive electrode plate may be a conventional positive plate in the art, for example, the positive electrode plate includes a positive electrode current collector and a positive electrode active material layer coated on a surface of either or both sides of the positive electrode current collector.

The positive electrode active material layer may include a positive electrode active material, a positive conductive agent, and a positive binder.

In an example, a mixing mass ratio of the positive electrode active material to the positive conductive agent and the positive binder ranges from (97-99):(0.5-1.5):(0.5-1.5) (for example, 97:1.5:1.5, 98:1:1, 98:0.5:1.5, 98:1.5:0.5, or 99:0.5:0.5).

In an example, the positive electrode active material is selected from lithium cobaltate (LiCoO₂) or lithium cobaltate (LiCoO₂) doped and coated with two or more elements in Al, Mg, Mn, Cr, Ti, or Zr; and a chemical formula of the lithium cobaltate doped and coated with two or more elements in Al, Mg, Mn, Cr, Ti, or Zr is Co_{1-y1-y2-y3-y4}A_{y1}B_{y2} C_{y3}D_{y4}O₂, where 0.95≤x≤1.05 (for example, 0.95, 0.96, 0.97, 0.98, 0.99, 1, 1.01, 1.02, 1.03, 1.04, or 1.05), 0.01≤y1≤0.1 (for example, 0.01, 0.02, 0.03, 0.04, 0.05, 0.06, 0.07, 0.08, 0.09, or 0.1), 0.01≤y2≤0.1 (for example, 0.01, 0.02, 0.03, 0.04, 0.05, 0.06, 0.07, 0.08, 0.09, or 0.1), 0≤y3≤0.1 (for example, 0, 0.01, 0.02, 0.03, 0.04, 0.05, 0.06, 0.07, 0.08, 0.09, or 0.1), 0≤y4≤0.1 (for example, 0, 0.01, 0.02, 0.03, 0.04, 0.05, 0.06, 0.07, 0.08, 0.09, or 0.1), and A, B, C, and D are independently selected from two or more elements in Al, Mg, Mn, Cr, Ti, or Zr. When y3 is 0, it means that there is no C in the chemical formula. When y4 is 0, it means that there is no D in the chemical formula.

In an example, 0≤y3≤0.1.

In an example, 0≤y4≤0.1.

In an example, the positive electrode active material is further selected from a ternary material (NCM or NCA) or a ternary material (NCM or NCA) doped and coated with two or more elements in Al, Mg, W, Sr, Mo, or Zr; and a chemical formula of the ternary material doped and coated with two or more elements in Al, Mg, W, Sr, Mo, or Zr is LiNiₓ Co_{y}Mn_{z}M_{1-x-y-z}O₂, where 0.33≤x≤0.96 (for example, 0.33, 0.4, 0.5, 0.6, 0.7, 0.8, 0.9, or 0.96), 0≤y≤0.33 (for example, 0, 0.1, 0.2, 0.3, or 0.33), 0.03 K z K 0.33 (for example, 00.03, 0.05, 0.08, 0.1, 0.2, 0.3, or 0.33), 0≤1−x−y−z≤0.005 (for example, 0.001, 0.002, 0.003, 0.004, or 0.005), and M is selected from two or more elements in Al, Mg, W, Sr, Mo, or Zr. When y is 0, it means that there is no Co in the chemical formula. When 1−x−y−z is 0, it means that there is no M.

In an example, 0≤y≤0.33.

In an example, 0≤1−x−y−z≤0.005.

In an example, the positive electrode active material is further selected from lithium iron phosphate (LFP) or lithium iron phosphate (LFP) doped and coated with two or more elements in Ti, W, V, Na, Mn, or Co; and a chemical formula of the lithium iron phosphate doped and coated with two or more elements in Ti, W, V, Na, Mn, or Co is LiFeₓPN₁₋ₓO₂, where 0.095≤x≤1 (for example, 0.095, 0.098, 0.1, 0.2, 0.3, 0.4, 0.5, 0.6, 0.7, 0.8, 0.9, or 1), 0.0001≤1−x<0.005 (for example, 0.0001, 0.0005, 0.001, 0.002, 0.003, 0.004, or 0.005), and N is selected from two or more elements in Ti, W, V, Na, Mn, or Co.

In an example, the conductive agent in the positive electrode active material layer is selected from acetylene black.

In an example, the binder in the positive electrode active material layer is selected from polyvinylidene fluoride (PVDF).

In an example, the negative electrode plate may be a conventional negative electrode plate in the art, for example, the negative electrode plate includes a negative electrode current collector and a negative electrode active material layer coated on a surface of either or both sides of the negative electrode current collector, and the negative electrode active material layer may include a negative electrode active material, a conductive agent, and a binder.

In an example, the negative electrode active material is selected from graphite.

In an example, the negative electrode active material further optionally includes SiOₓ/C or Si/C, where 0<x<2. For example, the negative electrode active material further contains 1-15 wt % SiOₓ/C, for example, 1 wt %, 2 wt %, 5 wt %, 8 wt %, 10 wt %, 12 wt %, 15 wt %, or any point value within a range formed by every two of the foregoing point values.

Since the battery of the present disclosure contains the separator described in the present disclosure, the internal resistance of the battery is reduced, so that the long-term cycling performance is improved, and the safety performance is improved; and the required aging time is reduced, so that the production efficiency is improved and the cost is reduced.

The following describes the present disclosure in detail by using embodiments. The embodiments described in the present disclosure are merely some, but not all of the embodiments of the present disclosure. All other embodiments obtained by a person of ordinary skill in the art based on the embodiments of the present disclosure without creative efforts fall within the protection scope of the present disclosure.

### Example I1

In this example, a first monomer having the structure shown in (I-1) was used for modification.

A separator was prepared according to the following steps.

(1) A substrate layer was modified.

After a matrix material polyolefin with a thickness of 5 μm was subjected to a plasma treatment for 6 minutes and activated, the polyolefin was treated in oxygen at a temperature of 45° C. for 150 minutes to obtain a matrix material rich in peroxide; the matrix material rich in peroxide was soaked in a first monomer solution (a solvent was acetone with an amount that made a weight ratio of the first monomer to the matrix material be 2:100), controlled at a temperature of 60° C. under a protective atmosphere, and reacted for 8 hours to obtain the modified substrate layer.

(2) Ceramic particles were modified and a heat-resistant layer was formed.

A first monomer was dissolved in an acetone solvent in a stirring manner to form an acetone solution containing the first monomer and a first polymer, aluminum oxide ceramic particles were added into the acetone solution containing the first monomer and the first polymer, and stirred and mixed for 2 hours, so that the first monomer was polymerized into a shell on a surface of the ceramic particle; and the obtained material was spray-dried to obtain the modified ceramic particles. The modified ceramic particles had a shell-core weight ratio of 20:100.

The modified ceramic particles (60 wt %), polyvinylidene fluoride (PVDF) (40 wt %) and acetone were mixed and stirred to obtain a slurry.

The obtained slurry was coated and cured on upper and lower surfaces of the substrate layer respectively to form a first heat-resistant layer and a second heat-resistant layer.

(3) PVDF was modified and an adhesive layer was formed.

After an adhesive material PVDF was subjected to a plasma treatment for 6 minutes and activated, the PVDF was treated in oxygen at a temperature of 45° C. for 150 minutes to obtain PVDF rich in peroxide; the PVDF rich in peroxide was soaked in a first monomer solution (a solvent was acetone with an amount that made a weight ratio of the first monomer to the adhesive be 10:100), controlled at a temperature of 60° C. under a protective atmosphere, and reacted for 8 hours to obtain the modified PVDF. The modified PVDF and dimethylacetamide (DMAC) were mixed with a solid content of 6% and stirred for 120 minutes at a speed of 1500 rpm to obtain a slurry. The obtained slurry was coated on surfaces of the first heat-resistant layer and the second heat-resistant layer to form a first adhesive layer and a second adhesive layer.

Finally, the separator composed of the first adhesive layer, the first heat-resistant layer, the substrate layer, the second heat-resistant layer and the second adhesive layer from bottom to top was obtained, and thicknesses of the layers were 1 μm, 2 μm, 5 μm, 2 μm, and 1 μm in sequence.

### Comparative Example 1

A separator prepared in this comparative example did not contain a modified monomer.

A polyethylene substrate was used as a substrate layer (denoted as Dⱼ).

One layer of aluminum oxide ceramic slurry was coated on both sides of the substrate layer to obtain a heat-resistant layer (denoted as Dₙ), the aluminum oxide ceramic slurry was prepared with reference to Example I1, except that the alumina ceramic was not modified.

One layer of adhesive material was coated on upper and lower surfaces respectively to obtain an adhesive material (denoted as Dₜ), the adhesive material was prepared with reference to Example I1, except that PVDF was not modified.

Finally, the separator composed of the first adhesive layer, the first heat-resistant layer, the substrate layer, the second heat-resistant layer and the second adhesive layer from bottom to top was obtained, and thicknesses of the layers were 1 μm, 2 μm, 5 μm, 2 μm, and 1 μm in sequence.

### Other Examples

Each example was performed with reference to Example I1, except that the substrate layer, the heat-resistant layer and the adhesive layer respectively changed the specific selection of the first monomer, or were not modified, as shown in Table 1.

The examples in Group I were used to represent examples modified by a monomer having a structure shown in Formula (I); the examples in Group II were used to represent examples modified by a monomer having a structure shown in Formula (II); and the examples in Group III were used to represent examples modified by monomers having structures shown in Formula (I) and Formula (II) together. These combinations are only used for examples, and all structural monomers of the present disclosure may be combined.

TABLE 1

| | Modified monomer of | Modified monomer of | Modified monomer of |
|---|---|---|---|
| Example | substrate layer | heat-resistant layer | adhesive layer |
| Comparative | — | — | — |
| Example 1 | | | |
| Example I1 | I-1 | I-1 | I-1 |
| Example I2 | I-2 | I-2 | I-2 |
| Example I3 | I-3 | I-3 | I-3 |
| Example I4 | I-1 | I-2 | I-3 |
| Example I5 | I-1 | I-1 | — |
| Example I6 | I-1 | — | I-1 |
| Example I7 | I-1 | — | — |
| Example I8 | — | I-1 | — |
| Example I9 | — | — | I-1 |
| Example II1 | II-1 | II-1 | II-1 |
| Example II2 | II-2 | II-2 | II-2 |
| Example II3 | II-3 | II-3 | II-3 |
| Example II4 | II-4 | II-4 | II-4 |
| Example II5 | II-5 | II-5 | II-5 |
| Example II6 | II-1 | II-1 | II-4 |
| Example III1 | I-1 | II-1 | I-2 |
| Example III2 | I-3 | II-3 | II-5 |
| Example III3 | I-3 | II-2 | II-2 |
| Example III4 | I-2 | II-2 | II-4 |

The separators obtained in the examples were used to respectively prepare batteries in the following manner.

### (1) Preparation of a Positive Electrode Plate

A positive electrode active material LiCoOO₂, a binder polyvinylidene fluoride (PVDF), and a conductive agent acetylene black were mixed at a weight ratio of 98:1.0:1.0. N-methylpyrrolidone (NMP) was added. Stirring was performed under action of a vacuum mixer until a mixed system became a positive electrode slurry with uniform fluidity. The positive electrode slurry was evenly applied on an aluminum foil having a thickness of 10 am. The coated aluminum foil was baked in a five-stage oven with different temperatures, dried at a 120° C. oven for 8 hours, followed by roll-pressing and cutting, to obtain the required positive electrode plate.

### (2) Preparation of a Negative Electrode Plate

A negative electrode material artificial graphite with a mass percentage of 9700, a conductive agent single-walled carbon nanotube (SWCNT) with a mass percentage of 0.10%, a conductive agent conductive carbon black (SP) with a mass percentage of 0.80%, a binder sodium carboxymethyl cellulose (CMC) with a mass percentage of 10%, and a binder styrene-butadiene rubber (SBR) with a mass percentage of 1.10% were made into a slurry by using a wet process. The slurry was applied on a surface of a copper foil with a thickness of 6 am of a negative electrode current collector, and then dried (temperature: 85° C., time: 5 hours), followed by rolling, and die cutting to obtain the negative electrode plate.

### (3) Preparation of a Non-Aqueous Electrolyte Solution

In a glove box filled with argon (moisture<10 ppm, oxygen<1 ppm), ethylene carbonate (EC), propylene carbonate (PC), and propyl propionate (PP) were evenly mixed at a mass ratio of 2:1.5:2, and LiPF₆ accounting for 14 wt % of a total mass of the non-aqueous electrolyte solution and ethyl propionate accounting for 5-60 wt % of the total mass of the non-aqueous electrolyte solution were slowly added into the mixed solution. The mixture was stirred evenly to obtain the non-aqueous electrolyte solution.

### (4) Separator

Separators used were the separators respectively obtained in the examples and comparative examples above.

### (5) Preparation of a Lithium-Ion Battery

The foregoing prepared positive electrode plate, separator, and negative electrode plate were wound to obtain an unfilled bare cell. The bare cell was placed in an outer packaging foil, the prepared electrolyte solution was injected into the dried bare cell, and after processes such as vacuum packaging, standing, forming, secondary packaging, and sorting, the lithium-ion battery required was obtained.

### Test Example

The separators and batteries obtained were tested respectively as follows:

### (1) Testing an Ionic Conductivity of a Separator

The separators obtained in the examples and comparative examples were placed in a (25±2°) C environment to prepare circular samples with a diameter of 40 mm. The samples were allowed to stand in an electrolyte solution having an ionic conductivity of 10±2 ms/cm for 2 hours. A completely dried conductance cell was taken, moistened with an electrolyte solution for 3 times, then a standard electrolyte solution was added into the conductance cell with a dropper, and a layer of the soaked separator was put into the conductance cell with tweezers. The prepared samples were subjected to an impedance test with an electrochemical workstation at a scanning frequency of 1 KHz to 100 KHz. According to the above test method, the impedance of the first to fifth layers of separators was sequentially tested to obtain the ionic conductivity of the separator.

100 sets of data were recorded, and an ionic conductivity deviation ratio was calculated. Ionic conductivity deviation ratio (%)=Maximum/Minimum×100%.

### (2) Testing Electrochemical Performances of a Battery

The batteries obtained in the above examples and comparative examples were placed in an environment of (25±2°) C to stand for 2 to 3 hours. When the battery bodies reached (25±2°) C, the batteries were charged at a constant current of 1 C, with a cut-off current of 0.05 C. After the batteries were fully charged, the batteries were left aside for 5 minutes, and then discharged at a constant current of 1 C to a cut-off voltage of 3.0 V. A highest discharge capacity for the first three cycles was recorded as an initial capacity Q. When the number of cycles reached 1000, the last discharge capacity Q1 of the battery was recorded. An initial thickness T of the cell was recorded, and when the thickness of the number of cycles reached 1000 was recorded as Ti, recorded results are shown in Table 2.

The calculation formula used is as follows: capacity retention rate (%)=Q₁/Q×100%.

The obtained results are recorded in Table 2.

TABLE 2

| | | Capacity retention rate (%) |
|---|---|---|
| | Ionic conductivity | of the battery |
| Source of the | deviation ratio (%) | (Cycling for 1000 cycles |
| separator | of the separator | at 25° C. and 1 C) |
| Comparative | 25.32 | —* |
| Example 1 | | |
| Example I1 | 6.72 | 72.9 |
| Example I2 | 6.24 | 74.66 |
| Example I3 | 5.84 | 76.29 |
| Example I4 | 6.94 | 72.82 |
| Example I5 | 6.83 | 72.86 |
| Example I6 | 7.46 | 72.49 |
| Example I7 | 8.92 | 70.82 |
| Example I8 | 7.12 | 72.65 |
| Example I9 | 8.47 | 72.05 |
| Example II1 | 6.64 | 73.47 |
| Example II2 | 6.37 | 74.42 |
| Example II3 | 6.33 | 74.53 |
| Example II4 | 5.86 | 75.86 |
| Example II5 | 5.73 | 76.32 |
| Example II6 | 6.53 | 73.99 |
| Example III1 | 6.35 | 74.48 |
| Example III2 | 6.23 | 74.64 |
| Example III3 | 6.12 | 75.33 |
| Example III4 | 6.21 | 74.62 |

Comparative Example 1 was a battery prepared from a conventional separator, and when a battery capacity retention rate of the battery was tested, the battery capacity retention rate was reduced to 60% after the battery capacity retention rate test was performed for 608 weeks, and then the battery capacity retention rate was reduced rapidly, and a 1000-cycle test could not be completed.

It may be learned from Table 2 by comparing the comparative examples and examples that, the ionic conductivity deviation ratios of the separators in the examples are obviously reduced, and the capacity retention rates of the batteries made of the separators in the examples are obviously improved, indicating that the introduction of at least one of the first monomer and the first polymer in the present disclosure improves the consistency of conducting ions of the separator, reduces the internal resistance of the battery, prolongs the cycle life of the battery and improves the safety performance of the battery.

The foregoing describes in detail an implementation of the present disclosure. However, the present disclosure is not limited thereto. Within the scope of the technical concepts of the present disclosure, various simple variations may be implemented to the technical solutions of the present disclosure, including combinations of technical features in any other suitable manner. These simple variations and combinations shall also be considered as the disclosure of the present disclosure and shall fall within the protection scope of the present disclosure.

What is claimed is:

1. A separator, wherein the separator contains a first monomer and/or a first polymer, and the first polymer is obtained by polymerizing the first monomer;
the first monomer has a structure shown in Formula (I) or Formula (II), 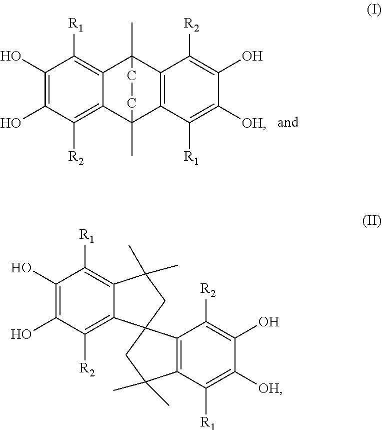
wherein R₁ and R₂ are each independently selected from H, —CₙNR₃, or —CₙNR₄R₅, and n is an integer from 0 to 4; NR₃ is a 4-7 membered heterocyclic ring, R₃ contains 0 to 2 oxygen atoms and/or 0 to 2 nitrogen atoms, and the balance are carbon atoms; there is or there is no grafting group R₆ on R₃, R₆ is —CₘOH, and m is an integer from 0 to 2; and R₄ and R₅ are each independently a C1-C4 aliphatic chain.

2. The separator according to claim 1, wherein n is 1 or 2; NR₃ is a five-membered or six-membered heterocyclic ring, R₃ contains 0 to 1 oxygen atom, and the balance are carbon atoms; there is or there is no grafting group R₆ on R₃, and R₆ is OH; and R₄ and R₅ are each independently selected from methyl and ethyl; and/or
—CₙNR₃ is selected from the following structures:

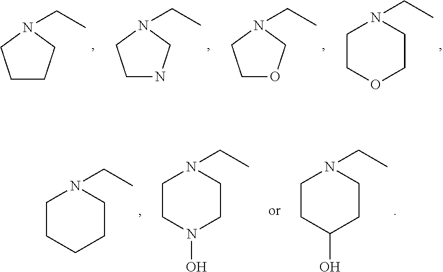

3. The separator according to claim 1, wherein the first monomer is selected from the following structures:

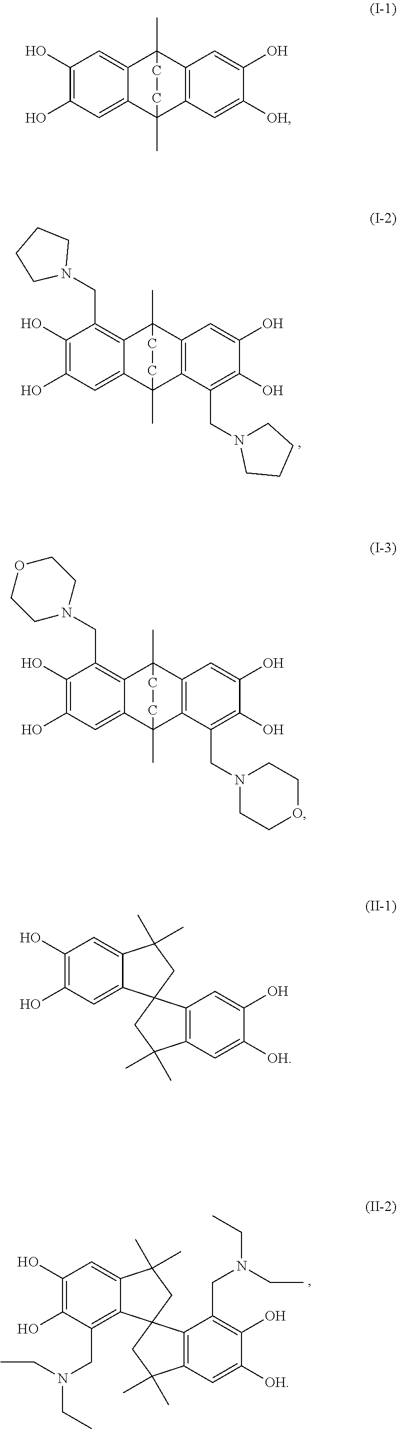 [SMILES: CC12CCC(C)(c3cc(O)c(O)cc31)c1cc(O)c(O)cc12 ; CC12CCC(C)(c3cc(O)c(O)c(CN4CCCC4)c31)c1c2cc(O)c(O)c1CN1CCCC1 ; CC12CCC(C)(c3cc(O)c(O)c(CN4CCOCC4)c31)c1c2cc(O)c(O)c1CN1CCOCC1 ; CC1(C)CC2(CC(C)(C)c3cc(O)c(O)cc32)c2cc(O)c(O)cc21 ; CCN(CC)Cc1c(O)c(O)cc2c1C1(CC2(C)C)CC(C)(C)c2cc(O)c(O)c(CN(CC)CC)c21]

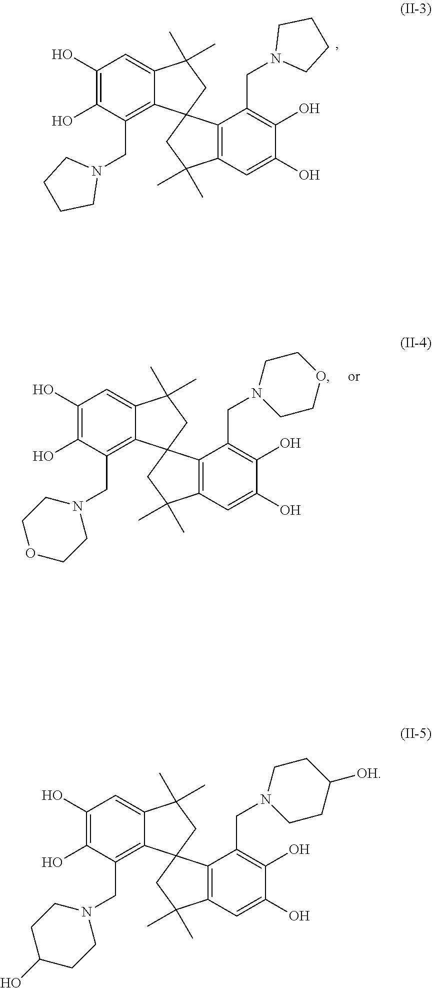 [SMILES: CC1(C)CC2(CC(C)(C)c3cc(O)c(O)c(CN4CCCC4)c32)c2c1cc(O)c(O)c2CN1CCCC1 ; CC1(C)CC2(CC(C)(C)c3cc(O)c(O)c(CN4CCOCC4)c32)c2c1cc(O)c(O)c2CN1CCOCC1 ; CC1(C)CC2(CC(C)(C)c3cc(O)c(O)c(CN4CCC(O)CC4)c32)c2c1cc(O)c(O)c2CN1CCC(O)CC1]

4. The separator according to claim 1, wherein the separator comprises a substrate layer and an optional heat-resistant layer and/or an optional adhesive layer; the heat-resistant layer covers one side or two side surfaces of the substrate layer; the adhesive layer covers a surface of the heat-resistant layer, and/or the adhesive layer covers a surface of the substrate layer.

5. The separator according to claim 4, wherein at least one of the substrate layer, the heat-resistant layer, or the adhesive layer contains the first monomer and/or the first polymer; and/or
at least the substrate layer contains the first monomer and/or the first polymer; and/or
the substrate layer, and at least one of the heat-resistant layer and the adhesive layer contain the first monomer and/or the first polymer; and/or
the heat-resistant layer and the adhesive layer contain the first monomer and/or the first polymer; and/or
the substrate layer, the heat-resistant layer and the adhesive layer all contain the first monomer and/or the first polymer.

6. The separator according to claim 4, wherein a material of the substrate layer comprises a material obtained by grafting and modifying a matrix material with the first monomer; and/or
a thickness of the substrate layer ranges from 2 μm to 20 μm.

7. The separator according to claim 6, wherein, relative to 100 parts by weight of the matrix material, a content of the first monomer ranges from 0.1 part by weight to 10 parts by weight; and/or
the matrix material is selected from one or more of polyethylene, polypropylene, polyvinylidene fluoride, polyimide, polyethylene terephthalate, polybutylene terephthalate, polystyrene, polynaphthalene system polymer, polyamide, poly(p-phenylene-2,6-benzoxadiazole), or aramid.

8. The separator according to claim 4, wherein the heat-resistant layer comprises ceramic particles and a first binder, and the ceramic particles have a core-shell structure, wherein a shell material of the ceramic particles comprises the first polymer, and the shell material of the ceramic particles is selected from one or more of aluminum oxide, boehmite, magnesium oxide, boron nitride, or magnesium hydroxide; and/or
a thickness of the heat-resistant layer ranges from 0.5 μm to 4 μm.

9. The separator according to claim 8, wherein the shell material of the ceramic particles comprises a homopolymer of the first monomer.

10. The separator according to claim 8, wherein, based on a total weight of the ceramic particles, a content of the shell material ranges from 5 wt % to 50 wt %, and a content of the core material ranges from 50 wt % to 95 wt %; and/or
based on the total weight of the heat-resistant layer, the content of the ceramic particles ranges from 20 wt % to 99 wt %, and the content of the first binder ranges from 1 wt % to 80 wt %.

11. The separator according to claim 8, wherein the first binder contains the first monomer and/or the first polymer.

12. The separator according to claim 4, wherein the adhesive layer comprises a modified second binder, and the modified second binder is obtained by grafting the first monomer and/or the first polymer on a base binder.

13. The separator according to claim 12, wherein the base binder is selected from one or more of polytetrafluoroethylene, polyvinylidene fluoride, hexafluoropropylene-vinylidene fluoride copolymer, polyimide, polyacrylonitrile, polymethyl methacrylate, polyacrylic acid, or polyacrylate.

14. The separator according to claim 12, wherein, relative to 100 parts by weight of the base binder, an amount of the first monomer ranges from 0.1 part by weight to 20 parts by weight.

15. The separator according to claim 14, wherein, relative to 100 parts by weight of the base binder, the amount of the first monomer ranges from 8 part by weight to 12 parts by weight.

16. The separator according to claim 4, wherein a thickness of the adhesive layer ranges from 0.5 μm to 2 μm.

17. The separator according to claim 1, wherein, relative to a total weight of the separator, a content of at least one of the first monomer and the first polymer ranges from 0.1 wt % to 20 wt %.

18. The separator according to claim 17, wherein, relative to the total weight of the separator, the content of at least one of the first monomer and the first polymer ranges from 0.5 wt % to 10 wt %.

19. A battery, comprising the separator according to claim 1.

20. The battery according to claim 19, wherein the battery is a lithium-ion battery.
